(19) United States
(12) Patent Application Publication
(10) Pub. No.: US 2008/0123481 A1
(43) Pub. Date: May 29, 2008

(54) Method for Saving ther Keylockers on Optical Discs

(75) Inventor: Wilhelmus Franciscus Johannes Fontijn, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/577,364

(22) PCT Filed: Oct. 12, 2005
(86) PCT No.: PCT/IB05/53354

§ 371 Date: Apr. 17, 2007

(30) Foreign Application Priority Data
Oct. 21, 2004 (EP) 04300704.6

(51) Int. Cl. G11B 5/09

(52) U.S. Cl. 369/47.1

(57) ABSTRACT

The present invention relates to a system with an integrated digital rights management mechanism. The system comprises a drive (120) and a host (130) controlling operations of the drive (120). The drive (120) receives an optical record carrier (102) and is designed to extract from the optical record carrier (102) a digital rights file including keys and rights respecting access to content (304) stored on the optical record carrier (102). The host (130) generates a dummy file (310) bearing structural characteristics similar to the driver digital rights file and transmits the dummy file (310) to the drive (120). Upon reception of the dummy file (310), the drive (120) completes the dummy file (310) by incorporating into the dummy file (310) sensitive data contained in the digital rights file and writes the dummy file (310) onto the carrier (102).

The present invention is in the field of optical storage and pertains to a protocol between host and drive for the inclusion of data onto record carriers. The invention proposes to integrate a security mechanism onto optical discs and the invention more particularly relates to the specifics of the writing of digital rights management data.

The generic file structure of writable optical storage media is specified in the Universal Disk Format (UDF) standard. The generic file system imposes conditions control data placement, and on operational read and write processes. Among these conditions, the UDF standard imposes an order in which discs sectors and data must be written. For example, the UDF standard specifies that for open CD-Rs, the last written sector must be the Information Control Block (ICB) of the Virtual Allocation Table (VAT). Meeting this requirement is crucial to the mounting process because failing to find the ICB where the driver assumes it to be located would cause reading errors and operation failure.

In addition to requirements imposed by generic file system standards such as the above, the electronic industry seeks to integrate technical security mechanisms to ensure that forfeiture of content is prevented as best possible and so that usage of available content may be closely monitored and restricted. Industry and content providers are thus strongly pushing towards a universal integration of digital rights management mechanisms in optical systems. To that respect, solutions are discussed in industry consortiums and standards result therefrom. Most approaches define stringent conditions that need be fulfilled to ensure product interoperability. One of the proposed solutions is referred to as the Sapphire solution. The Sapphire project describes keys and rights respecting protected content on the disc and these keys and rights are securely stored in a so-called KeyLocker Area (KLA) in the program area or in the lead-in portion of the disc. One of the specifics is that the KLA is written just before the ICB associated with the VAT. Entry-point for the DRM data is contained in a DRM pointer entry, in particular in an adaptation layer parameter space (ALP), where physical locations of all Key Locker duplicates are listed. The Key Locker is the structure that contains both the rights and the keys to the protected data. The KLA is the area on the disc reserved for the Key Locker and the ALP. For a recordable (write once) access type optical disc or sequential access type discs, DRM data can be located anywhere in the program area, and the DRM pointer entry can be located anywhere after the DRM data. European patent application No. 2004/021345A1, hereby incorporated by reference, discloses one way to find the DRM data stored on a disc. This document discloses a way of accessing digital rights management data stored within the program area of a recordable or rewritable record carrier. The proposed solution adds an entry in the disc to allow the drive to find the DRM pointer entry (ALP), which leads to the DRM data stored on the disc.

However writing the KLA in a location different from the one prescribed in the Sapphire project may delay disc reading and content playing. For example, if a non-Sapphire compliant drive adds data to the KLA in a non-compliant way, the situation arises where the KLA is no longer at the prescribed location. If the KLA cannot be easily found in the prescribed location next to the ICB, the drive's operating system first needs to scan the entire disc before processing the stored content and such scanning may delay the overall operation.

As hereinbefore stated, the UDF standard imposes a condition on the ICB location on the disc and current standardization efforts tend to impose conditions on the positioning of the KLA. Both requirements therefore need be met in parallel. Such arrangement works well when reading since the ICB will be the last written sector of the program area and the KLA will be positioned nearby. Problems arise while updating and writing the KLA. Indeed, in a host/drive optical system both entities are responsible for writing data but none is in full control when using generic UDF standard. And one must design systems that comply with the Sapphire specification or any other specification that would impose the same restriction on DRM data without impacting the general structure of the disc.

KLA data includes sensitive data and in order to prevent forfeiture of content access rights, the KLA data may not be communicated to applications running on the host. Sensitive KLA data is thus kept at the drive and the host has got little knowledge of the characteristics of the KLA and of the information contained therein. Only selected items from the KLA may be communicated to selected applications on the host. A consequence of this is that the host does not know how much disc space the KLA takes and it may send a command to write content onto the disc while there is not enough space left.

There is thus a great need for a host/drive system where host and drive share partial knowledge of the KLA and where the host application artificially controls the writing of the KLA onto the record carrier.

An object of one or more embodiments of the invention is to provide a system that seamlessly integrates digital rights management between the host and the drive without risking the integrity of keys and content access rights.

Another object of one or more embodiments of the invention is to provide a system where the host artificially controls the writing of digital rights management data onto the record carrier.

To this end, a system of the invention includes a host controlling operations of a drive and a drive for reading and writing data onto an optical record carrier. The drive may retrieve from the optical record carrier a digital rights file including keys and rights respecting access to content stored on the optical record carrier. The host in turn generates a dummy file bearing structural characteristics similar to the drive's digital rights file and transmits the dummy file to the drive. Upon reception of the dummy file, the drive completes the dummy file with sensitive data contained in the digital rights file and writes the completed dummy file onto the carrier.

The invention is based on the premises that the host has got partial knowledge of the KLA file. Based on the specifics of the KLA file that the host knows, an application at the host generates a dummy KLA file having like specifics. For example, the host creates a file with the same size and/or the same internal architecture as the real KLA file stored at the drive's side without any sensitive data contained in the file. In the invention the host transmits the dummy file to the drive. When receiving the dummy file, the drive replaces data in the dummy file or files it up with data from the KLA stored locally at the drive. Then, the drive controls the writing of the now completed dummy file onto the record carrier. Although, the file ultimately written on the record carrier is referred to as “dummy”, it is the actual final KLA file. An advantage of the invention is to artificially shift control of the KLA to the host. Indeed, the host initiates the update of the KLA and although the dummy file does not contain sensitive data, the overall structure of the dummy file and communication protocol between the host and the drive may be such that the system functions “as if” the host were in control of the writing of the KLA. This shift of control permits to transfer partial knowledge of the KLA to the host, which may optimize other operations accordingly. For example, the host knows how much space is needed for the KLA and controls the writing of content onto the record carrier based on the remaining space. Typically, the host was neither aware of the KLA nor the space it occupied on the disc. This difference between what the host assumes the situation of the disc is and the reality was likely to cause problems. In addition, the host sees the KLA as a file now and there is a reference to the KLA in the host file system. A file reference in the file system permits to locate the KLA speedily and efficiently and avoids scanning the whole disc. An advantage of the invention is that the proposed solution is transparent to a UDF implementation of the drive. The invention thus also relates to an apparatus having a host and a drive interface for performing the same.

The invention further relates to a method for writing digital rights management data onto a record carrier, a computer-readable storage medium for storing computer executable instructions for carrying out such a method.

These and other aspects of the invention will be apparent from and will be elucidated with reference to the embodiments described hereinafter.

The present invention will now be described in more detail, by way of example, with reference to the accompanying drawings, wherein:

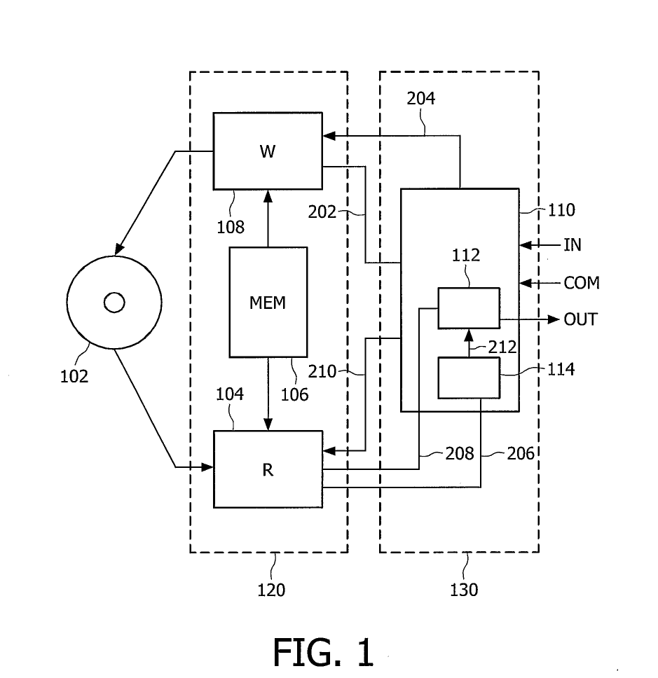

FIG. 1 is a system of the invention; and

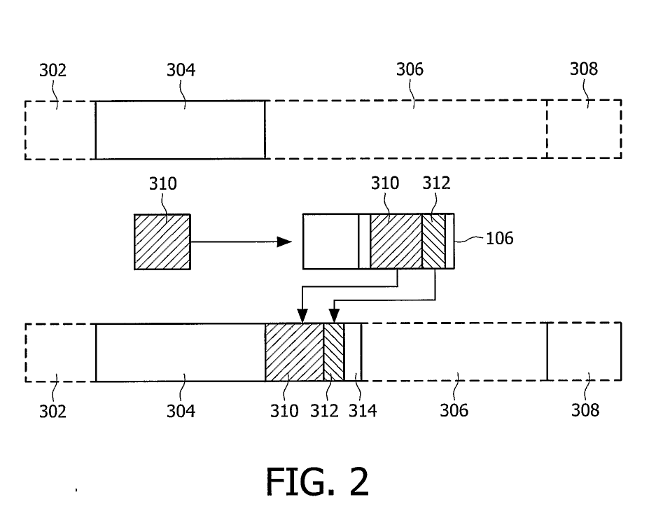

FIG. 2 illustrates the writing of the KLA onto the disc carrier.

Throughout the drawing, the same reference numeral refers to the same element, or an element that performs substantially the same function.

FIG. 1 shows a block diagram of a reproduction system 100 according to the present invention. To read user data from disc 102, reading unit 104 is provided. Content providers and device manufacturers seek to develop digital rights management (DRM) systems, which define usage restriction on part or all of the user data. This means that content stored on disc 102 may be encrypted, and disc 102 may store cryptographic keys used to decrypt content before the user can process it. Further, usage rights can be stored on disc 102 that would indicate if a user is allowed to make copies, read out or exchange pieces of content with other users. Such usage rights and keys shall be referred to as DRM data. Reading unit 104 is further provided to read such DRM data. However pointers pointing to DRM data first need be found and reading unit 104 is provided to that effect with an evaluation unit. Evaluation unit is not shown in FIG. 1. Once evaluation unit in reading unit 104 has located the DRM pointer, DRM data is provided to control block 114 via lead 206. Control block 114 is located within a digital signal processing unit (DSP) 110 responsible for processing content and format specific data on disc 102 when content is either written on or played out from disc 102. The read DRM data is used to control the output of user data, i.e. control unit 114 controls content play-out unit 112 of DSP 110, for instance by prohibiting the output of the output signal OUT if a usage right prohibits the output or by enabling data decryption before data is played out to the user. The invention is by no way limited to the usage rights and the key encryption mechanism described above and other usage restrictions or any other type of control on content access or processing is hereby encompassed.

Reproduction system 100 of FIG. 1 may accept writable-type discs and as such, additionally includes a write unit 108 for the writing of content on disc 102. Disc 102 is a CD-R based on the Orange book part II specification, i.e. disc 102 is writable once however the general principal of the invention may also be applied to rewritable discs or other types of optical storage media. For example, the invention is also relevant to upcoming Blue Ray discs, specifically BD-R and DVD+R/−R.

Data IN provided to an input of DSP unit 110 is conveyed to write unit 108 via lead 204. DSP 100 may control via control lead 202 how write unit 108 performs the writing of data IN onto disc 102. DSP 100 may also control the writing onto disc 102 of data taken from memory arrangement 106 of system 100 as will be explained hereinafter.

Reproduction system is also equipped with memory arrangement 106 for storing content, user data and format specific data associated with disc 102. Memory arrangement 106 may contain a transient memory portion for storing sets of data with short life cycles, i.e. sets of data that may be disposed of after a reading or writing cycle or once the inserted disc 102 is ejected. Memory arrangement 106 may also contain permanent storage portions for permanent storage of user and standard specific data and content, erasable or not.

In this exemplary embodiment, system 100 is UDF and Sapphire compliant. In one embodiment of the invention, the overall optical system is split in a drive portion 120 and a host portion 130 where applications are run. In a personal computer environment, the host 130 is mostly composed of the PC hardware and operating system. In one embodiment, memory 106, write unit 108 and read unit 104 are physically located in drive 120 and DSP 110 is part of host 130. In another exemplary embodiment, control unit 114 may be located at the drive and sensitive DRM data such as keys and rights stored in the KLA are not transmitted to host 130.

The writing/update of the KLA area on disc 102 will be explicated by means of example as follows. The update of the KLA may be carried out in response to an external request or system 100 may be designed to automatically trigger the update under certain conditions. In a first embodiment, a software application in control of the writing of content on disc 102 sends a command to the write unit 108 to write the KLA upon completion of the content storage. Such application may run in DSP 110 or outside system 100. The write command may be part of a writing procedure and for example, terminates any writing of content on disc 102. Thus, whenever DSP 110 controls the writing of a set of data secured by associated DRM rights, the writing is ultimately accompanied by a command to write the KLA data representing the DRM rights. The KLA data may represent a new set of digital rights and may have been received along with content to be written on disc 102 previously stored in memory arrangement 106. Alternately, writing the KLA may include a modification of the actual KLA area stored on disc 102. DSP 110 may also issue the write command when pending updates of the KLA data temporarily stored in memory arrangement 106 were postponed for too long. Updates of the KLA on disc 102 may also take place at regular time intervals.

In another embodiment, the KLA data is written upon ejection of disc 102 from system 100. DSP 110 keeps track of whether the KLA cached in memory arrangement 106 has been changed. The KLA is changed when content is written. Occasionally, the KLA may also be updated when content is read. For example, rights to view a movie may restrict to a user to a maximum number of viewing. Thus, when content is viewed the KLA data associated with the movie is cached and updated in memory arrangement 106. Ultimately when disc 102 is ejected or system 100 powered off in response to an external command COM, system DSP 110 checks whether updates of the KLA data are pending in arrangement 106 and modifies the KLA on disc 102 accordingly before ejecting it or before shutting down.

Writing or updating the KLA may be initiated in the specific circumstances described above, however the invention encompasses any other situations not described which ultimately lead to the writing of new digital rights or the modification of existing digital rights.

In an embodiment of the invention, update of the KLA takes place as follows. First, a dummy file 310 is created in host 130. DSP 110 creates dummy file 310 a parts of an internal routine governing the update of the KLA area on disc 102. Or an application running on host 130 may control DSP 110 to create dummy file 310. DSP 110 has limited knowledge of the KLA and dummy file 310 is built based on the known characteristics of the KLA in order to resemble the actual KLA data. Dummy file 310 and the actual KLA data may thus have similar internal file structure, the same size, similar names but dummy file 310 does not contain sensitive data kept in memory 106. DSP 110 may calculate the size of the dummy file 310 from the size of the original KLA it had received or there may be a standardised command to retrieve it from the drive 120. The filename of dummy file 310 may be such that that it is unlikely that another application will use the same file name and the content of dummy file 310 may be such that drive 120 may check whether dummy file 310 is really the KLA or not. The original KLA had been previously retrieved from optical carrier 102 and cached in memory 106. Upon retrieval, structural characteristics of the KLA was conveyed to the host or DSP 110 and sensitive data, e.g. keys and rights, is securely stored in memory 106.

FIG. 2 illustrates the update of the KLA. FIG. 2 shows the internal format of record carrier 102. Record carrier includes reserved lead-in portion 302, stored content 304, reserved program area 306 not written yet and reserved lead-out portion 308. Host 130 transmits dummy file 310 to the drive portion of system 100. Drive 120 recognizes dummy file 310 as such and in response to it, retrieves sensitive data from the KLA that had been cached in memory 106 and fills in dummy file 310 with it. Drive 120 may also operate a reformatting of dummy file 310. A similar operation may be performed for the ALP file 312 containing pointers to the KLA.

The foregoing merely illustrates the principles of the invention. It will thus be appreciated that those skilled in the art will be able to devise various arrangements which, although not explicitly described or shown herein, embody the principles of the invention and are thus within the spirit and scope of the following claims.

In interpreting these claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) each of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts is intended to be required unless specifically indicated.

1. A system comprising:
a drive for receiving an optical record carrier and extracting from the optical record carrier a digital rights file including keys and rights respecting access to content stored on the optical record carrier;
a host controlling operations of the drive;
characterized in that
the host generates a dummy file bearing structural characteristics similar to the driver digital rights file based on items associated with the digital rights file and transmits the dummy file to the drive; and,
the drive, upon reception of the dummy file, completes the dummy file by incorporating into the dummy file sensitive data contained in the digital rights file and writes the completed dummy file onto the carrier.

2. The system of claim 1, wherein the dummy file and the digital rights file have at least one of the following characteristics: size, name or internal structure.

3. The system of claim 1, wherein the digital rights file is a Key Locker Area as specified in the Sapphire specification.

4. An apparatus comprising:
a drive interface for interfacing with a drive where an optical record carrier is positioned and receiving from the drive items associated with a digital rights file including keys and rights respecting access to content stored on the optical record carrier;
a host controlling operations of the drive interface;
characterized in that
the host generates a dummy file bearing structural characteristics similar to the driver digital rights file based on the received items and transmits the dummy file to the drive interface; and
the drive interface controls the drive to complete the dummy file by incorporating into the dummy file sensitive data contained in the digital rights file and to write the completed dummy file onto the carrier.

5. A method for integrating a digital rights management mechanism in a system including a drive for receiving an optical record carrier and extracting from the optical record carrier a digital rights file including keys and rights respecting access to content stored on the optical record carrier and a host controlling operations of a drive, the method comprising the steps of:
generating a dummy file bearing structural characteristics similar to the driver digital rights file;
transmitting the dummy file to the drive; and,
controlling a completion of the dummy file by incorporation of sensitive data contained in the digital rights file into the dummy file;
controlling a writing of the completed dummy file onto the carrier.

6. A computer-readable storage medium storing computer-executable instructions for carrying out a method for integrating a digital rights management mechanism in a system including a drive for receiving an optical record carrier and extracting from the optical record carrier a digital rights file including keys and rights respecting access to content stored on the optical record carrier and a host controlling operations of a drive, the method comprising the steps of:
generating a dummy file bearing structural characteristics similar to the driver digital rights file;
transmitting the dummy file to the drive; and,
controlling a completion of the dummy file by incorporation of sensitive data contained in the digital rights file into the dummy file;
controlling a writing of the completed dummy file onto the carrier.
